(19) United States
(12) Patent Application Publication
(10) Pub. No.: US 2007/0103939 A1
(43) Pub. Date: May 10, 2007

(54) Sectional light emitting diode backlight unit

(76) Inventors: Teng-Huei Huang, Hsin-Chu Hsien (TW); Chu-Ping Fan, Taipei Hsien (TW); Chien-Lung Lee, Nan-Tou Hsien (TW)

Correspondence Address: NORTH AMERICA INTELLECTUAL PROPERTY CORPORATION, P.O. BOX 506, MERRIFIELD, VA, 22116, US

(21) Appl. No.: 11/383,753

(22) Filed: May 16, 2006

(30) Foreign Application Priority Data
Nov. 8, 2005 (TW) 094219305

(51) Int. Cl. F21V 7/04

(52) U.S. Cl. 362/633

(57) ABSTRACT

A sectional light emitting diode backlight unit comprising a circuit board, a frame disposed on the circuit board, a plurality of light emitting diode dies disposed on the circuit board inside the frame, each light emitting diode die being electrically connected to a circuit on the circuit board, a plurality of connecting pads disposed on a first side of the circuit board outside the frame, the connecting pads being electrically connected to a circuit on the circuit board, and an encapsulating material positioned on the circuit board inside the frame to cover the light emitting diode dies; wherein at least one second side of the circuit board has a connection means for connecting to another sectional light emitting diode backlight unit.

### BACKGROUND OF THE INVENTION

1. Field of the Invention

The present invention relates to a light emitting diode (LED) backlight unit, and more particularly to a sectional LED backlight unit.

2. Description of the Prior Art

Most of the light source generators in the traditional liquid crystal display (LCD) backlight units are cold cathode fluorescent lamps (CCFL) nowadays, but since the CCFL consists of mercury (Hg), the CCFL will be possibly superseded under the requirement for green merchandises in the future. The light emitting diode (LED) is being substituted for the CCFL stage by stage as the light source generators in the LCD, LCD TV, or other flat display panels with various sizes. In addition, the light intensity per watt of the LED is gradually becoming higher enough for application in the backlight unit due to the improvement in the LED technology.

In a conventional LED backlight unit, the LED package is positioned directly under the panel, and a reflector is positioned in the bottom of the backlight unit to reflect light by a flat reflecting structure. However, for a better optical performance, this conventional LED backlight unit will have the disadvantages of larger thickness and non-uniform luminance.

Please refer to FIG. 1. FIG. 1 shows another conventional LED backlight unit 10 using dies positioned on the substrate to form a package structure. As shown in FIG. 1, the LED backlight unit 10 comprises a silicon substrate 11, an array formed by LED dies 18 positioned on a surface 12 of the silicon substrate 11, and a circuit layer 17 formed on the surface 12 of the silicon substrate 11 to electrically connect to the LED dies 18. The circuit layer 17 is connected to a power supply device at two electrodes 16. This kind of LED backlight unit has a fixed size when being assembled, and thus it is not able to match the flat display panels having different sizes.

Therefore, it is still necessary to develop a LED backlight unit that can be conveniently utilized in the flat display panel with large size.

### SUMMARY OF THE INVENTION

An objective of the present invention is to provide a sectional light emitting diode backlight unit that can be combined as a direct light backlight unit with proper size according to the display panel size.

According to the present invention, the sectional light emitting diode backlight unit comprises a circuit board, a frame disposed on the circuit board, a plurality of light emitting diode dies disposed on the circuit board inside the frame, each light emitting diode die being electrically connected to a circuit on the circuit board, a plurality of connecting pads disposed on a first side of the circuit board outside the frame, the connecting pads being electrically connected to a circuit on the circuit board, and an encapsulating material positioned on the circuit board inside the frame to cover the light emitting diode dies; wherein at least one second side of the circuit board has a connection means for assembly with another sectional light emitting diode backlight unit.

The sectional light emitting diode backlight unit according to the present invention can be combined as a large-sized backlight unit for a large-sized display panel such as LCD TV. Therefore, the present invention has the advantages as follows. The backlight unit can be manufactured in a relatively smaller size with a simpler package process, and combined as a direct light backlight unit with proper size when applied to a large-sized flat display panel. Since the circuit of each backlight unit is independent, it is convenient to replace it when failed. A plurality of light emitting diode dies are directly disposed on the circuit board so that the resulting backlight unit thickness is thinner than using a plurality of mono-chip light emitting diode packages disposed on the circuit board. A desired luminance of the backlight unit can be maintained by a local adjustment in accordance with the decrease of light intensity sensed by a light sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of a conventional LED backlight unit.

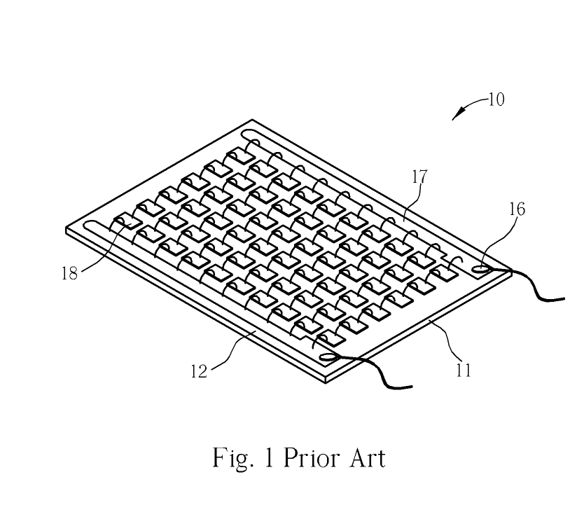

FIG. 2 shows a sectional LED backlight unit according to an embodiment of the present invention.

FIG. 3 shows a schematic cross-sectional view of the sectional LED backlight unit shown in FIG. 2.

FIG. 4 shows a schematic cross-sectional diagram of another embodiment of the sectional LED backlight unit according to the present invention.

FIG. 5 shows a schematic diagram of still another embodiment of the sectional LED backlight unit according to the present invention.

FIG. 6 shows a schematic diagram of further another embodiment of the sectional LED backlight unit according to the present invention.

FIG. 7 shows a schematic diagram of an embodiment of a direct light LED backlight unit combined by the sectional LED backlight units according to the present invention.

### DETAILED DESCRIPTION

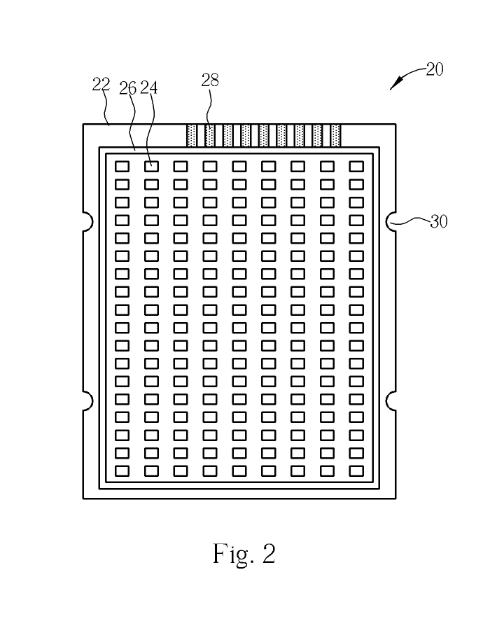

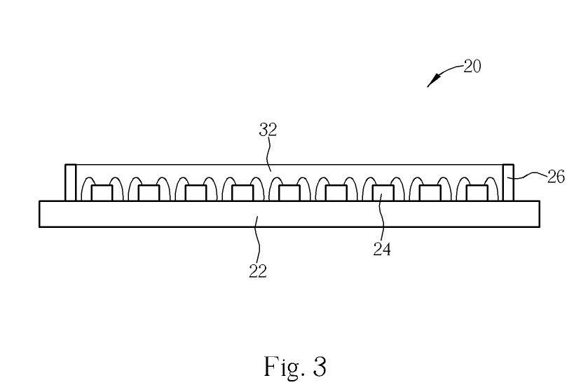

Please refer to FIG. 2 and FIG. 3. FIG. 2 shows an embodiment of the sectional LED backlight unit according to the present invention, and FIG. 3 is a schematic cross-sectional view of the sectional LED backlight unit shown in FIG. 2. The sectional LED backlight unit 20 comprises a circuit board 22, a plurality of LED dies 24, a frame 26, a plurality of connecting pads 28, and an encapsulating material 32, wherein the circuit board 22 has one or more connection means 30 for assembly with one or more another sectional LED backlight units to form a larger backlight device.

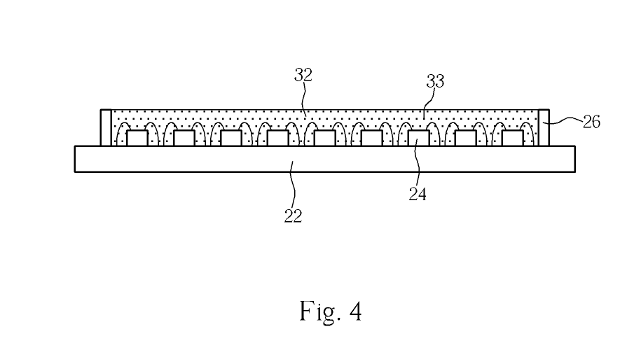

The circuit board 22 has a circuit to electrically connect the LED dies or other components positioned on the circuit board with a control device or power supply device. Since the high power LED backlight unit produces relatively more heat, materials with better heat conduction are preferred to be the circuit board. The circuit can be designed as a single layer or multi-layer as desired. It is preferred that the circuit board has a reflecting layer on the surface in order to improve light efficiency of the whole sectional LED backlight unit. The frame 26 is disposed on the circuit board 22 to contain the follow-up encapsulating material 32. Transparent material can be chosen for a transparent frame to avoid shadow on the display panel, but it is not limited. Other opaque materials also can be chosen for an opaque frame. A plurality of LED dies 24 are disposed on the circuit board 22 inside the frame 26, and each LED die 24 is electrically connected to the circuit board 22 by using a flip chip method or a wiring bonding method. A plurality of connecting pads 28 are disposed on one side of the circuit board 22 outside the frame 26, and the connecting pads 28 are electrically connected to the circuit on the circuit board 22 in order to be electrically connected with external devices. Each sectional LED backlight unit 20 has an independent circuit. The encapsulating material 32 is positioned on the circuit board 22 inside the frame 26 to cover the LED dies 24, and the encapsulating material 32 may include, for example, an organic molding compound, a ceramic material permeable to light, a glass material permeable to light, an insulation fluid material permeable to light, or a composite material comprising at least two materials selected from a group consisting of the above-mentioned materials. The encapsulating material 32 may further include at least a wavelength converting material or a scatterer dispersed in the encapsulating material 32 or coated on the encapsulating material 32. For example, the wavelength converting material can be fluorescent material (phosphor), or the like. FIG. 4 is a diagram of another embodiment of the sectional LED backlight unit according to the present invention, wherein the encapsulating material 32 further includes the scatterers 33 dispersed in the encapsulating material 32. The scatterer 33 may include a ceramic material permeable to light, a glass material permeable to light, or the like. The shape and size of the scatterer 33 is not limited.

In the sectional LED backlight unit according to the present invention, the plurality of LED dies are arranged in array form, and directly disposed on the circuit board, and thus the sectional LED backlight unit thickness is relatively thinner. Different color LED dies and wavelength converting materials are used according to the desired color of light from the sectional LED backlight unit. For example, red LED dies, green LED dies, and blue LED dies are used to generate a white light, or ultraviolet LED dies are used with red, green, and blue light-emitting wavelength converting materials together to generate a white light, or ultraviolet LED dies and blue LED dies are used with green and red light-emitting wavelength converting materials to generate a white light.

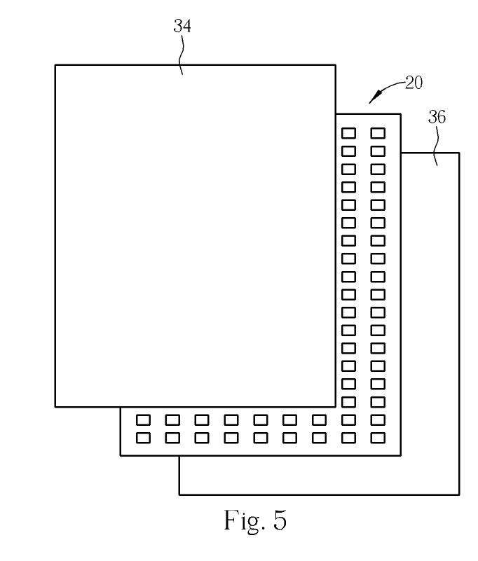

Please refer to FIG. 5. FIG. 5 shows another embodiment of the sectional LED backlight unit according to the present invention. According to the present invention, the sectional LED backlight unit 20 may further comprise a diffuser plate 34 positioned over the LED dies 24 to diffuse light, such that the light emitted from the backlight unit is uniform and gentle. The sectional LED backlight unit 20 also may comprise a heat dissipation device 36 to dissipate heat, and the circuit board 22 is positioned on the heat dissipation device 36 for quick transmission of heat away from the backlight unit. For example, the heat dissipation device 36 can be a heat dissipating plate, a heat dissipating fin, a heat dissipating sink, or a heat dissipating pipe. In addition, a heat dissipating paste or gel can be filled between the circuit board 22 and the heat dissipation device 36.

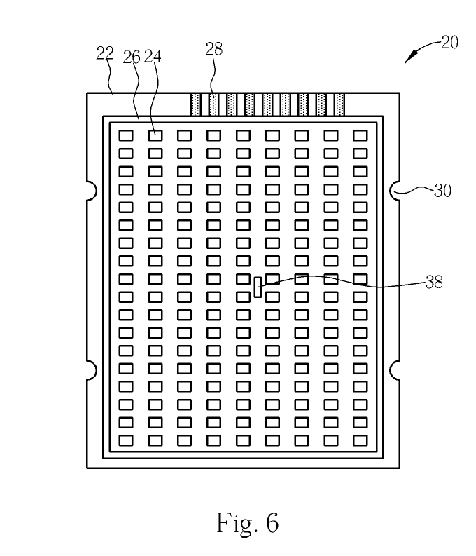

Please refer to FIG. 6. FIG. 6 shows further another embodiment of the sectional LED backlight unit according to the present invention. According to the present invention, the sectional LED backlight unit 20 may further comprise a light sensor 38 positioned on the circuit board 22 to sense light intensity, and the light sensor 38 is electrically connected to a controller that controls light emission of the LED dies, so that the intensity of light emitted from the LED dies 24 can be adjusted through the controller according to the corresponding data of light intensity sensed by the light sensor 38. Location of the light sensor 38 is not limited, but it is preferred that the light sensor 38 is positioned in the center of the circuit board 22 to obtain a representative light intensity. A plurality of light sensors also can be installed to monitor the light intensity of the LED dies 24 around, and the power for the LED dies 24 to emitting light can be adjusted by using the controllers accordingly. For the sectional LED backlight units, one light sensor is enough if the single LED backlight unit size is not large. The purpose of installing the light sensor 38 inside the sectional LED backlight unit 20 is to compensate the luminance immediately. After the sectional LED backlight unit 20 is used for a period of time, the light intensity sensed by the light sensor 38 might decline, and the controller can increase electric power to the LED dies 24 to increase the luminance in order to maintain a good light output of the sectional LED backlight unit 20.

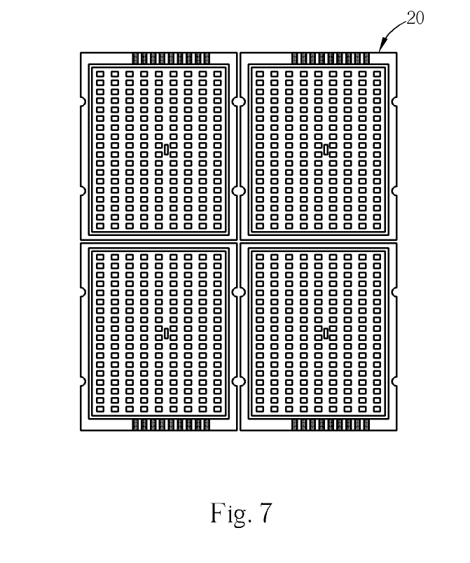

According to the present invention, at least one side of the circuit board 22 in the sectional LED backlight unit 20 has a connection means for connecting to another sectional LED backlight unit to be an assembled backlight unit having a size as desired. FIG. 7 shows an embodiment of a direct light LED backlight unit combined by the sectional LED backlight units 20 according to the present invention, and the direct light LED backlight unit can be utilized in a large-sized display panel. In FIG. 7, four sectional LED backlight units 20 according to the present invention are connected to each other. For example, the two sectional LED backlight units 20 are connected to each other and fixed on the heat dissipation device by using screw holes and screws. The screw holes can be positioned on the circuit board edge, and the screw holes are, for example, semicircular for not occupying the circuit board area too much, so that when the two sectional LED backlight units 20 are connected to each other, a circular hole is formed. Then, the screws are used to fix the two sectional LED backlight units 20, and it is convenient for assembly. In addition, the heat dissipation device can be a heat dissipating plate with larger size that is able to support and collocate to fix the sectional LED backlight units 20. As the combination shown in FIG. 7, the length of the combination can be further increased to obtain a desired display panel size.

Furthermore, other connection means also can be utilized for the combination of the sectional LED backlight units 20. For example, the sectional LED backlight units 20 can be connected by using tenons, or adhesion, or an indented edge of the circuit board for connecting with each other. It is preferred to avoid a joint black band occurring in the joint area.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sectional light emitting diode backlight unit, comprising:
a circuit board;
a frame disposed on the circuit board;
a plurality of light emitting diode dies disposed on the circuit board inside the frame, each light emitting diode die being electrically connected to a circuit on the circuit board;
a plurality of connecting pads disposed on a first side of the circuit board outside the frame, the connecting pads being electrically connected to a circuit on the circuit board; and
an encapsulating material positioned on the circuit board inside the frame to cover the light emitting diode dies;
wherein at least one second side of the circuit board has a connection means for assembly with another sectional light emitting diode backlight unit.

2. The sectional light emitting diode backlight unit of claim 1, wherein the light emitting diode dies are arranged in array form.

3. The sectional light emitting diode backlight unit of claim 1, wherein the light emitting diode dies comprise red light emitting diode dies, green light emitting diode dies, and blue light emitting diode dies.

4. The sectional light emitting diode backlight unit of claim 1, wherein the light emitting diode dies comprise ultraviolet light emitting diode dies.

5. The sectional light emitting diode backlight unit of claim 1, wherein the light emitting diode dies comprise ultraviolet light emitting diode dies and blue light emitting diode dies.

6. The sectional light emitting diode backlight unit of claim 1, wherein the encapsulating material includes an organic molding compound, a ceramic material permeable to light, a glass material permeable to light, an insulation fluid material permeable to light, or a composite material comprising at least two materials selected from a group consisting of the above-mentioned materials.

7. The sectional light emitting diode backlight unit of claim 1, further comprising at least a wavelength converting material dispersed in the encapsulating material or coated on the encapsulating material.

8. The sectional light emitting diode backlight unit of claim 1, further comprising at least a scatterer dispersed in the encapsulating material or coated on the encapsulating material.

9. The sectional light emitting diode backlight unit of claim 8, wherein the scatterer includes a ceramic material permeable to light or a glass material permeable to light.

10. The sectional light emitting diode backlight unit of claim 1, further comprising a diffuser plate positioned on the light emitting diode dies to diffuse light.

11. The sectional light emitting diode backlight unit of claim 1, further comprising a heat dissipation device to dissipate heat, and the circuit board is positioned on the heat dissipation device.

12. The sectional light emitting diode backlight unit of claim 1, further comprising a light sensor positioned on the circuit board to sense light intensity, and the light sensor is electrically connected to a controller that controls light intensity of the light emitting diode dies.

13. The sectional light emitting diode backlight unit of claim 1, wherein the connection means comprises a tenon.

14. The sectional light emitting diode backlight unit of claim 1, wherein the connection means is realized by forming an indented edge of the circuit board for connecting with each other.

15. The sectional light emitting diode backlight unit of claim 1, wherein the connection means is realized by adhesion.

16. The sectional light emitting diode backlight unit of claim 1, wherein the connection means is realized by a screw hole and a screw.

17. The sectional light emitting diode backlight unit of claim 11, wherein the connection means is realized by a screw hole and a screw to combine the two sectional light emitting diode backlight units and to fix the two sectional light emitting diode backlight units on the heat dissipation device.

18. A sectional light emitting diode backlight unit combination, comprising:
a heat dissipation device for dissipating heat;
a plurality of sectional light emitting diode backlight units positioned on the heat dissipation device, each of the sectional light emitting diode backlight units comprising:
a circuit board;
a frame disposed on the circuit board;
a plurality of light emitting diode dies disposed on the circuit board inside the frame, each light emitting diode die being electrically connected to a circuit on the circuit board;
a plurality of connecting pad disposed on a first side of the circuit board outside the frame, the connecting pads being electrically connected to a circuit on the circuit board;
an encapsulating material positioned on the circuit board inside the frame to cover the light emitting diode dies; and
at least a connection means positioned on at least one second side of the circuit board;
wherein the sectional light emitting diode backlight units are assembled with each other by the connection means; and
a diffuser plate, positioned on the sectional light emitting diode backlight units to diffuse light.
